(19) United States
(12) Patent Application Publication
(10) Pub. No.: US 2010/0169973 A1
(43) Pub. Date: Jul. 1, 2010

(54) System and Method For Detecting Unknown Malicious Code By Analyzing Kernel Based System Actions

(76) Inventors: Ki Hong Kim, Seoul (KR); Ga Ram Jung, Seoul (KR); Hyun Cheol Jeong, Seoul (KR); Chae Tae Im, Seoul (KR); Seung Goo Ji, Yongin (KR); Sang Kyun Noh, Gwangju (KR); Joo Hyung Oh, Seoul (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/571,825

(22) Filed: Oct. 1, 2009

(30) Foreign Application Priority Data
Dec. 30, 2008 (KR) 10-2008-0136230

(51) Int. Cl. G06F 11/00

(52) U.S. Cl. 726/23; 726/24

(57) ABSTRACT

There is provided a system and method for detecting unknown malicious code by analyzing kernel based system actions. More particularly, the system and method provides an advantage of actively countering unknown malicious code or viruses by monitoring kernel based system events in real time, organizing action data based on the collected event data, determining whether the action data corresponds to predetermined malicious actions, backtracking a subject of a malicious action when the action data is determined to correspond to the malicious action, and processing the malicious action.

### CROSS-REFERENCE TO RELATED APPLICATIONS

This application claims the priority of Korean Patent Application No. 10-2008-0136230 filed on Dec. 30, 2008, in the Korean Intellectual Property Office, the disclosure of which is incorporated herein by reference.

### BACKGROUND OF THE INVENTION

1. Field of the Invention

The present invention relates to a system and method for detecting unknown malicious code by analyzing kernel based system actions, and more particularly, to a system and method for actively countering unknown malicious code or viruses by monitoring kernel based system events in real time, organizing action data based on the collected event data, determining whether the action data corresponds to predetermined malicious actions, backtracking a subject of a malicious action when the action data is determined to correspond to the malicious action, and processing the malicious action.

2. Description of the Related Art

The detection of malicious code or viruses has usually been performed based on files. According to the related art, the extraction of the characteristics of all known malicious code files, such as patterns or hash values, and their storage in a malicious code database have been required in order to detect malicious code. After extracting the characteristics of all files present in a system, the extracted characteristics of those files have been compared with malicious action data stored in the malicious code database. If the characteristics of files present in the system correspond with those stored in the malicious code database, these corresponding system files have been determined to be malicious code.

According to the related art as above, there is an advantage in that when the characteristics of malicious code files are stored in the malicious code database, corresponding malicious code can be detected rapidly and accurately. However, when the characteristics of malicious code files are not stored in the malicious code database, that is, in a case of unknown malicious code, it is impossible to detect the unknown malicious code. Although malicious code may have been identified, when the known malicious code is mutated, even though it may cause the same detrimental effects, it is difficult to detect it.

Also, according to the related art, since the individual inspection of all files present in the system has been required to detect malicious code, the time taken to detect malicious code is lengthened.

Particularly, in the case of malicious code, such as bots, which may produce 4000 or more mutative codes in a single day, the collection of samples of all mutative malicious code files and the individual extraction of the characteristics of these malicious code files from the samples are required. Therefore, memory efficiency and detection rates deteriorate.

### SUMMARY OF THE INVENTION

An aspect of the present invention provides a system and method for actively countering unknown malicious code or viruses, by monitoring kernel based system events in real time, organizing action data based on the collected event data, determining whether the action data corresponds to predetermined malicious actions, backtracking a subject of a malicious action when the action data is determined to correspond to the malicious action, and processing the malicious action.

According to an aspect of the present invention, there is provided a system for detecting unknown malicious code by analyzing kernel based system actions, the system including: a monitoring driver installed at a kernel level, monitoring kernel based system events in real time, and collecting event data; and a malicious code detecting and processing unit organizing action data based on the event data collected by the monitoring driver, determining whether the action data corresponds to predetermined malicious actions, backtracking a subject of a malicious action when the action data is determined to correspond to the malicious action, and processing the malicious action.

The monitoring driver may include at least one of a process monitoring driver monitoring process-related events, a file monitoring driver monitoring file-related events, a registry monitoring driver monitoring registry-related events, a network monitoring driver monitoring network-related events, and a system monitoring driver monitoring system-related events other than process, file, registry and network-related events.

The system monitoring driver may monitor a ReadVirtualMemory or WriteVirtualMemory system call event.

The system for detecting unknown malicious code by analyzing kernel based system actions may further include a malicious action database having predetermined malicious action data stored therein.

The malicious code detecting and processing unit may include an action data organizing module organizing action data based on the event data collected by the monitoring driver, a malicious action determining module comparing the action data with malicious action data stored in the malicious action database and determining whether the action data corresponds to malicious actions, and a malicious action processing module backtracking a subject of a malicious action that is determined by the malicious action determining module and processing the malicious action.

The malicious action processing module may perform at least one of a blocking of the malicious action, a forced termination of the subject of the malicious action, a deletion of a file causing the malicious action, and a notification of a user.

According to another aspect of the present invention, there is provided a method of detecting unknown malicious code by analyzing kernel based system actions, the method including: monitoring kernel based system events in real time; organizing action data based on the collected event data; determining whether the action data corresponds to predetermined malicious actions; backtracking a subject of a malicious action when the action data is determined to correspond to the malicious action; and processing the malicious action.

The monitoring of the kernel-based system events may be performed for at least one of process-related events, file-related events, registry-related events, network-related events, and system-related events other than process, file, registry and network-related events.

The processing of the malicious action may include performing at least one of a blocking of the malicious action, a forced termination of the subject of the malicious action, a deletion of a file causing the malicious action, and a notification of a user.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a system for detecting unknown malicious code by analyzing kernel based system actions according to an exemplary embodiment of the present invention; and

FIG. 2 is a flowchart illustrating the detection process of unknown malicious code by analyzing kernel based system actions according to another exemplary embodiment of the present invention.

### DETAILED DESCRIPTION OF THE PREFERRED EMBODIMENT

Exemplary embodiments of the present invention will now be described in detail with reference to the accompanying drawings. However, detailed descriptions related to well-known functions or configurations will be ruled out in order not to unnecessarily obscure subject matters of the present invention. Also, the same reference numerals will be used throughout the drawings to refer to the same or like parts.

Moreover, throughout the specification, when one part is specified as being connected to another part, this includes not only a “direct connection,” but also an “indirect connection,” that is, they may be indirectly connected, with an intervening part therebetween. In addition, unless explicitly described to the contrary, the word “include” and variations such as “includes” or “including,” will be understood to imply the inclusion of stated elements but not the exclusion of any other elements.

Furthermore, the term “module” defines a unit that performs a particular function or operation, and this can be realized by hardware components, software components, or the combination of hardware and software components.

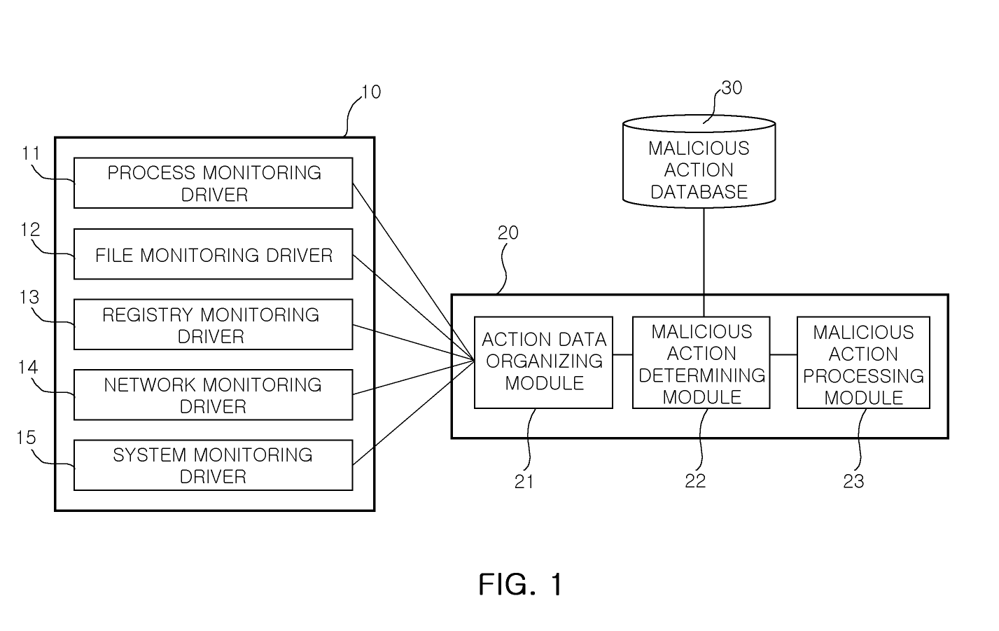

FIG. 1 is a block diagram illustrating a system for detecting unknown malicious code by analyzing kernel based system actions according to an exemplary embodiment of the present invention. The system for detecting the unknown malicious code includes a monitoring driver 10, a malicious code detecting and processing unit 20, and a malicious action database 30.

The monitoring driver 10 is installed at a kernel level, collects event data by monitoring various events occurring in a system in real time, and transfers the collected event data to the malicious code detecting and processing unit 20.

The monitoring driver 10 may include at least one of a process monitoring driver 11 monitoring process-related events, a file monitoring driver 12 monitoring file-related events, a registry monitoring driver 13 monitoring registry-related events, a network monitoring driver 14 monitoring network-related events, and a system monitoring driver 15 monitoring system-related events other than process, file, registry and network-related events. Here, these respective drivers operate independently of one another.

Specifically, the system monitoring driver 15 may be configured to monitor system call events which are performed inside a kernel for operating a computer system. For example, ReadVirtualMemory is a system call used when one process A tries to read the memory of another process B. Since ReadVirtualMemory is a system internal function that is called when malicious code tries to discover the operating state of other anti-virus solutions, it may be an object to be monitored. Also, WriteVirtualMemory is a system call used when one process A tries to write in the memory of another process B. Since WriteVirtualMemory is a system internal function that is called when trying to record desired values in the memory of another process that malicious code tries to attack, it may be an object to be monitored.

The malicious code detecting and processing unit 20 receives the event data collected by the monitoring driver 10, organizes action data based on the received event data, determines whether the action data corresponds to predetermined malicious actions, backtracks the subject of a malicious action when the action data is determined to correspond to the malicious action, and processes the malicious action. The malicious code detecting and processing unit 20 may include an action data organizing module 21, a malicious action determining module 22, and a malicious action processing module 23.

The action data organizing module 21 organizes action data based on the event data received from the monitoring driver 10. Here, the action data may include event types, event contents, and data. The following Tables 1 to 5 represent concrete examples of action data organized based on process-related events, file-related events, registry-related events, network-related events, and system-related events other than process, file, registry and network-related events, respectively.

TABLE 1

| Event Type | Event Contents | Data |
|---|---|---|
| Process | Creation | Process Route Information |
| Process | Termination | Process Route Information |

TABLE 2

| Event Type | Event Contents | Data |
|---|---|---|
| File | Creation | File Path Information |
| File | Writing | File Path Information |
| File | Deletion | File Path Information |
| File | Revision | File Path Information |

TABLE 3

| Event Type | Event Contents | Data |
|---|---|---|
| Registry | Key Creation | Registry Key Path |
| | | Information |
| Registry | Key Deletion | Registry Key Path |
| | | Information |
| Registry | Key Value | Registry Key value |
| | Creation | Information |
| Registry | Key value | Registry Key value |
| | Deletion | Information |

TABLE 4

| Event Type | Event Contents | Data |
|---|---|---|
| Network | DNS | DNS Request Information (DNS |
| | | Address) |
| Network | HTTP | HTTP Request Information |
| | | (Web Server Address, Request |
| | | Data) |
| Network | Socket | Socket Creation Information |
| | | (Protocol, IP, Port) |

TABLE 5

| Event Type | Event Contents | Data |
|---|---|---|
| ReadVirtualMemory | System Call Calling | Respective Function |
| | | Calling Information |
| WriteVirtualMemory | System Call Calling | Respective Function |
| | | Calling Information |
| LoadLibrary | System Call Calling | Respective Function |
| | | Calling Information |

The action data organized as shown in Tables 1 to 5 by the action data organizing module 21 may be stored in a kernel memory and deleted as soon as the analysis of the malicious action determining module 22 is completed.

The malicious action determining module 22 determines whether the action data formed by the action data organizing module 21 corresponds to predetermined malicious actions, that is, malicious actions predetermined in the malicious action database 30. For this, the malicious action determining module 22 reads malicious action data which is stored in the malicious action database 30 and determines whether the action data includes data corresponding to the malicious action data.

When it is determined by the malicious action determining module 22 that the action data corresponds to a malicious action, the malicious action processing module 23 backtracks the subject of the determined malicious action and processes the determined malicious action.

Specifically, the malicious action processing module 23 is able to detect the subject of the malicious action from a process ID included in the action data. When the subject of the malicious action is detected, the malicious action processing module 23 is able to properly respond to the detection of malicious code by countermeasures such as the blocking of the malicious action, the forced termination of the subject (for example, a process or operating module) of the malicious action, the deletion of a corresponding file causing the malicious action, and the notification of a user.

The malicious action database 30 has predetermined malicious action data stored therein. Here, malicious actions are defined by standardizing actions that various malicious code or viruses commonly undertake, and the malicious action data is written based on kernel-based system events which occur when malicious code or viruses are actually running. Therefore, the malicious action data may have the same organization as the action data presented in Tables 1 to 5. Also, the malicious action data may be encoded so as to have a form which is not recognized by common users.

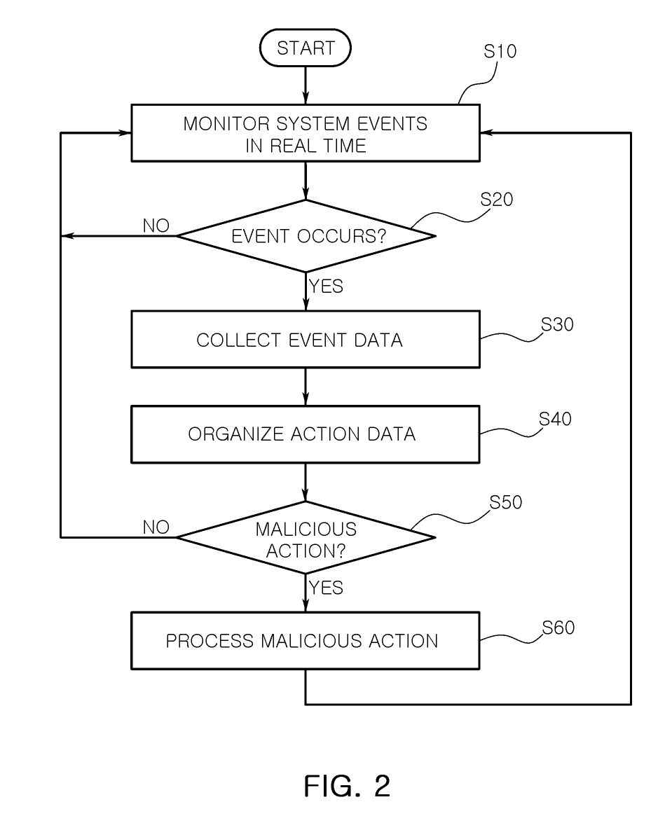

FIG. 2 is a flowchart illustrating the detection process of unknown malicious code by analyzing kernel-based system actions according to another exemplary embodiment of the present invention.

First of all, various events occurring at a kernel level of a system are monitored in real time in operation S10. At this time, such monitoring is performed for at least one of process-related events, file-related events, registry-related events, network-related events, and system-related events other than process, file, registry and network-related events.

When an event occurs in operation S20, event data is collected in operation S30 and action data is organized based on the collected event data in operation 40. At this time, the organization of the action data is same as described above, so a detailed description thereof will be omitted.

Then, it is determined whether the action data organized based on the event data corresponds to predetermined malicious actions in operation S50. When it is determined that the action data corresponds to a malicious action, the subject of the determined malicious action is backtracked and processed in operation S60.

Specifically, the subject of the malicious action is detected by using a process ID included in the action data. When the subject of the malicious action is detected, it is able to properly cope with the detection of malicious code by taking countermeasures such as the blocking of the malicious action, the forced termination of the subject (for example, a process or operating module) of the malicious action, the deletion of a corresponding file causing the malicious action, and the notification of a user.

As set forth above, according to exemplary embodiments of the present invention, a process or module causing malicious actions can be detected by organizing the action data based on the event data collected by monitoring the system events at the kernel level in real time, and then determining whether the action data corresponds to the predetermined malicious actions.

Therefore, if malicious actions are predetermined in detail, even though the characteristics of individual malicious code files, such as patterns or hash values, are not stored, malicious code causing malicious actions can be detected. This then ensures that neither the collection of samples of individual mutative malicious code files whenever mutative malicious code is generated nor the extraction of the characteristics of those malicious code files from the samples are required, whereby unknown malicious code or viruses can be actively countered.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for detecting unknown malicious code by analyzing kernel based system actions, the system comprising:
a monitoring driver installed at a kernel level, monitoring kernel based system events in real time, and collecting event data; and
a malicious code detecting and processing unit organizing action data based on the event data collected by the monitoring driver, determining whether the action data corresponds to predetermined malicious actions, backtracking a subject of a malicious action when the action data is determined to correspond to the malicious action, and processing the malicious action.

2. The system of claim 1, wherein the monitoring driver comprises at least one of a process monitoring driver monitoring process-related events, a file monitoring driver monitoring file-related events, a registry monitoring driver monitoring registry-related events, a network monitoring driver monitoring network-related events, and a system monitoring driver monitoring system-related events other than process, file, registry and network-related events.

3. The system of claim 2, wherein the system monitoring driver monitors a ReadVirtualMemory or WriteVirtualMemory system call event.

4. The system of claim 1, further comprising a malicious action database having predetermined malicious action data stored therein.

5. The system of claim 4, wherein the malicious code detecting and processing unit comprises:
an action data organizing module organizing action data based on the event data collected by the monitoring driver;
a malicious action determining module comparing the action data with malicious action data stored in the malicious action database and determining whether the action data corresponds to malicious actions; and
a malicious action processing module backtracking a subject of a malicious action that is determined by the malicious action determining module and processing the malicious action.

6. The system of claim 5, wherein the malicious action processing module performs at least one of a blocking of the malicious action, a forced termination of the subject of the malicious action, a deletion of a file causing the malicious action, and a notification of a user.

7. A method of detecting unknown malicious code by analyzing kernel based system actions, the method comprising:
monitoring kernel based system events in real time;
organizing action data based on the collected event data;
determining whether the action data corresponds to predetermined malicious actions;
backtracking a subject of a malicious action when the action data is determined to correspond to the malicious action; and
processing the malicious action.

8. The method of claim 7, wherein the monitoring of the kernel-based system events is performed for at least one of process-related events, file-related events, registry-related events, network-related events, and system-related events other than process, file, registry and network-related events.

9. The method of claim 7, wherein the processing of the malicious action comprises performing at least one of a blocking of the malicious action, a forced termination of the subject of the malicious action, a deletion of a file causing the malicious action, and a notification of a user.
